(19) United States
(12) Patent Application Publication
(10) Pub. No.: US 2013/0344259 A1
(43) Pub. Date: Dec. 26, 2013

(54) PEARL TREATMENT COMPOSITION AND METHOD

(71) Applicant: ATLAS PEARLS AND PERFUMERS LTD, Claremont (AU)

(72) Inventors: Stephen Paul Birkbeck, Claremont (AU); Christian Sarbach, Le Plessis Robinson (FR)

(21) Appl. No.: 13/925,007

(22) Filed: Jun. 24, 2013

(30) Foreign Application Priority Data
Jun. 22, 2012 (AU) 2012902645

(51) Int. Cl. C09K 15/34

(52) U.S. Cl. CPC C09K 15/34
USPC 427/601; 106/12; 427/443.2

(57) ABSTRACT

An alcohol-free aqueous pearl treatment composition that includes a water-based emulsion of particle size less than 1.0 microns, wherein, in use, the alcohol-free aqueous pearl treatment composition infuses into pearls to inhibit ageing of the pearls. This disclosure describes a method for the treatment of pearls including the steps of:
a) introducing into a bath an alcohol-free aqueous composition, the composition comprising a water-based emulsion of particle size less than 1.0 microns;
b) introducing one or more pearls into the bath; and
c) operating the bath for a prescribed period to allow the alcohol-free aqueous composition to infuse into the one or more pearls in a first treatment step;
wherein, in use, the alcohol-free aqueous composition inhibits ageing of the one or more pearls.

### FIELD OF THE INVENTION

The present invention relates to an alcohol-free aqueous treatment composition for pearls or pearl derivatives such as pearl nacre. The invention also describes the use of the composition for the delivery of active chemical compounds to the body of the pearl for the purposes of inhibiting ageing of the pearl, for providing nourishment, or for transporting perfume into the pearl. The invention also relates to a method for the treatment of pearls using the composition.

### BACKGROUND TO THE INVENTION

Pearls are used in many forms of jewellery, such as pendants, earrings, bracelets, rings, and so on. Pearls have always had a reputation of being associated with quality jewellery, and have for many centuries been highly valued as objects of beauty.

Cultured or farmed pearls are usually grown in pearl oysters and mussels, located in suitable freshwater or seawater pearl farms. Pearls are made up of calcium carbonate in crystalline form, which has been deposited in layers during its formation. Due to the layered nature of pearls, pearls are subject to damage and ageing. For example it is well known that perfume which contains alcohol (ethanol) damages pearls. This of course can present a problem since many women, who are the greatest wearers of pearl jewellery, also like to use perfume.

Pearls are valued according to a number of qualities such as lustre, colour, size, symmetry and lack of surface flaws. Ageing of a pearl can affect some or all of these qualities, in particular the colour, for example, where white pearls can become yellow with time. In cases of severe ageing, the pearl can disintegrate.

The ageing and damage of pearls is therefore a problem, in particular in cases where the pearls form part of an expensive piece of jewellery. The ageing of pearls is also a problem for retailers where pearl jewellery may be held in stores for lengthy periods of time prior to sale. Thus there is a need to find a way to treat pearls to assist in slowing down or halting the ageing process.

There are few methods for treating pearls to assist in anti-ageing of the pearls. A traditional Japanese treatment referred to as Maishori treatment is a surface treatment. It commonly uses peroxide and ultra-violet light to whiten pearls. The method has short-term advantages in restoring colour, but as it only treats the surface it has limited long term anti-ageing impact. Treating pearls in this way with peroxide can lead to damage and bleaching of the pearls if the treatment is too harsh or is undertaken on pearls with weak external nacre.

High value pearls are often lost or stolen, or may be broken down and sold as individual pieces. Currently the only method available to identify pearls is via computer chips embedded into the nuclei that are seeded into the oysters, although this method has not enjoyed widespread use due to its cost. Thus there is also a need to find a way to add an invisible but traceable chemical marker to a pearl which would allow forensic identification by a simple analysis technique.

It is to be understood that use of the word “pearl” throughout the specification includes all kinds and colours of pearls, including freshwater pearls, seawater pearls, cultured pearls, and naturally occurring pearls. The word “pearl” is also to be understood to include pearl derivatives, such as pearl nacre, “mother-of-pearl” and such variations.

The term “pearl matrix” as used in the specification is to be understood to mean the body of the pearl, or the layers of the pearl forming the structure of the pearl or pearl derivative.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided an alcohol-free aqueous pearl treatment composition comprising a water-based emulsion of particle size less than 1.0 microns, wherein, in use, the alcohol-free aqueous pearl treatment composition infuses into pearls to inhibit ageing of the pearls.

Preferably the water-based emulsion of the alcohol-free aqueous pearl treatment composition is mixed with an active chemical compound, the emulsion acting as a carrier to transport the active chemical compound into the pearl matrix.

Preferably the active chemical compound may be selected from one or more of the group comprising an anti-oxidant compound, a chelating agent, pheromone, radioactive substance, luminescent substance, fluorophores, phosphorescent substance, essential oils, or pearl nacre powder. Alternatively the active chemical compound may be a marker substance such as a fluorescing compound or isotopically labelled compound which may be used for biomarking or forensic identification of the pearls.

The anti-oxidant compound may be one or more of a perfume composition, butylated hydroxyanisole, butylated hydroxytoluene, propyl gallate, tocopherol, ascorbyl palmitate, alpha tocopheryl acetate, co-enzyme Q10, magnesium ascorbyl phosphate, arbutin, resveratrol, kojic acid, pentaerythrityl tetra di-tertiary butyl hydroxyhydrocinnamte, or superoxide dismutase.

The chelating agent may be tetrasodium EDTA, tetrahydroxypropyl ethylenediamine or Glucono-Delta-Lactone (GDL).

The pearl treatment composition may further comprise a fragrance concentrate, wherein the anti-oxidant compound is present in the fragrance concentrate. The fragrance concentrate may typically be present in a range of about 8-10% of the final composition.

Preferably the water-based emulsion has a particle size of less than 0.5 microns. The water-based emulsion is preferably the emulsion sold under the trade mark “WPE” of the French laboratory AR2i. The water-based emulsion is preferably plant-based. The water-based plant emulsion preferably comprises harmless plant emulsifiers, such as saponins. The water-based plant emulsions may contain up to 40% oily substances.

The pearl treatment composition may also comprise further water as required to provide a composition of suitable aqueous concentration.

The pearl treatment composition may also comprise a protein or amino acid extract such as conchiolin, perlucin Arginine, lysine, histidine, phenylalanine, tyrosine, leucine, isoleucine, methionine, valine, alanine, glycine, proline, glutamic acid, serine, threonine, aspartic acid, tryptophan, cystine, and taurine.

The pearl treatment composition may also comprise a colour enhancer, such as silver lustre (Merck ref 1.20602).

The pearl treatment composition may also comprise ceramides, such as sphingolipids which are composed of a sphingosine and a fatty acid, wherein the fatty acid may be any of the fatty acids found in human borne triglycerides and may include cerebroside, galactocerbroside, glucerebroside and lactosylceramide.

The pearl treatment composition may typically comprise: 0.01%-30% pearl nacre; fragrance concentrate 0.01%-29%; active chemical compound 0.01%-29%; and water-based emulsion 70%-99%.

The pearl treatment composition may typically comprise the following: fragrance concentrate 10%; WPE 3.9%; water 84.1%; and silver lustre (Merck 1.20602).

Advantageously the aqueous pearl treatment composition can also act as a chemical marker for forensic identification when the composition is infused into the pearl.

According to a further aspect of the present invention there is provided an alcohol-free aqueous pearl derivative treatment composition comprising a water-based emulsion of particle size less than 1.0 microns, wherein, in use, the alcohol-free aqueous pearl derivative treatment composition infuses into the pearl derivative to inhibit ageing of the pearl derivative.

Preferably the pearl derivative is pearl nacre.

The composition may further comprise an active chemical compound mixed with the water-based emulsion, whereby in use the water-based emulsion acts as a carrier to transport the active chemical compound into the pearl derivative in the infusion step, the active chemical compound assisting in inhibiting ageing of the pearl derivative.

According to a still further aspect of the present invention there is provided an alcohol-free aqueous pearl treatment composition comprising:
i) a water-based emulsion of particle size less than 1.0 microns; and
ii) a perfume concentrate;

wherein, in use, the water-based emulsion acts as a carrier for the perfume concentrate to allow the perfume to infuse into the body of the pearl.

According to another aspect of the present invention there is provided an alcohol-free aqueous pearl treatment composition comprising:
i) an anti-oxidant compound; and
ii) a water-based emulsion of particle size less than 1.0 microns;

wherein, in use, the alcohol-free aqueous pearl treatment composition infuses into pearls to inhibit ageing of the pearls.

According to a yet another aspect of the present invention there is provided an alcohol-free aqueous pearl treatment composition comprising a water-based emulsion of particle size less than 1.0 microns, wherein, in use, the alcohol-free aqueous pearl treatment composition infuses into pearls to provide a benefit.

Preferably the benefit is provided to the pearls and/or the wearer of the pearls. Preferably the benefit to the pearls is to inhibit ageing of the pearls, and/or nourishment or hydration of the pearls. The benefit may be to the user of the pearls, such as infusing of a perfume into the pearls which provides for perfumed pearls, possibly with the slow release of the perfume over time.

According to another aspect of the present invention there is provided an alcohol-free aqueous pearl treatment composition comprising a water-based solution of particle size less than 1.0 microns, wherein, in use, the alcohol-free aqueous pearl treatment composition infuses into pearls to inhibit ageing of the pearls.

According to another aspect of the present invention, there is provided a method for the treatment of pearls comprising the steps of:
a) introducing into a bath an alcohol-free aqueous composition, the composition comprising a water-based emulsion of particle size less than 1.0 microns;
b) introducing one or more pearls into the bath; and
c) operating the bath for a prescribed period to allow the alcohol-free aqueous composition to infuse into the one or more pearls in a first treatment step;
wherein, in use, the alcohol-free aqueous composition inhibits ageing of the one or more pearls.

Preferably the composition also comprises an active chemical compound mixed with the water-based emulsion. Preferably the active chemical compound is selected from a group comprising one or more of an anti-oxidant compound, a chelating agent, or pearl nacre powder.

Preferably the water-based emulsion has a particle size of less than 0.5 microns.

Preferably the bath is an ultrasonic bath. Preferably the bath is operated at a temperature of less than 50° C.

The method may also comprise the step of placing the one or more pearls into a beaker prior to introducing the pearls into the bath. The beaker may be made of glass or stainless steel.

Preferably the prescribed period of the first treatment step is about 15 to 60 minutes. More preferably the prescribed period is about 30 minutes.

Preferably the method further comprises a stirring step after the first treatment step in which the one or more infused pearls is stirred in the composition for a period of time. The period of time may be about 5 to 15 minutes.

Following the stirring step, the bath containing the one or more infused pearls may be operated for a second prescribed period. Typically the second prescribed period is about 30 minutes.

The method may comprise a final drying step during which the one or more infused pearls may be removed from the bath, and dried at ambient temperature.

The method may also comprise the step of operating the bath under elevated pressure. Preferably the pressure would be about 800 kPa. Preferably the step of operating the bath under elevated pressure would take place for about 15 to 60 minutes. More preferably the bath would be operated under elevated pressure for about 30 minutes.

According to another aspect of the present invention, there is provided a method for the treatment of pearls comprising the steps of:
a) introducing into a pressure vessel an alcohol-free aqueous composition, the composition comprising a water-based emulsion of particle size less than 1.0 microns;
b) introducing one or more pearls into the pressure vessel;
c) introducing carbon dioxide into the pressure vessel; and
d) operating the pressure vessel at a pressure in the range of +250 PSI to −2000 PSI for a prescribed period to allow the alcohol-free aqueous composition to infuse into the one or more pearls in a first treatment step;
wherein, in use, the alcohol-free aqueous composition inhibits ageing of the one or more pearls.

Preferably the water-based emulsion is mixed with an active chemical compound, the emulsion acting as a carrier to transport the active chemical compound into the pearl matrix.

According to another aspect of the present invention, there is provided a method for the treatment of pearls comprising the steps of:
a) introducing into a pressure vessel carbon dioxide and an active chemical compound;
b) introducing one or more pearls into the pressure vessel;
c) operating the pressure vessel at a pressure in the range of +250 PSI to −2000 PSI for a prescribed period to allow the active chemical compound to infuse into the one or more pearls in a first treatment step;
wherein, in use, the active chemical compound inhibits ageing of the one or more pearls.

Preferably the method also provides introducing into the pressure vessel a water-based emulsion of particle size less than 1.0 microns. Preferably the water-based emulsion is mixed with the active chemical compound prior to introduction into the pressure vessel.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### DETAILED DESCRIPTION OF PREFERRED EMBODIMENTS

A preferred embodiment of the alcohol-free aqueous pearl treatment composition according to the invention comprises a water-based emulsion of particle size less than 1.0 microns, wherein, in use, the alcohol-free aqueous pearl treatment composition infuses into pearls to inhibit ageing of the pearls.

Preferably the water-based emulsion of the alcohol-free aqueous pearl treatment composition is mixed with an active chemical compound, the emulsion acting as a carrier to transport the active chemical compound into the pearl matrix.

Preferably the active chemical compound may be selected from one or more of the group comprising an anti-oxidant compound, a chelating agent, pheromone, radioactive substance, luminescent substance, fluorophores, phosphorescent substance, essential oils, or pearl nacre powder. The anti-oxidant compound may be a perfume composition, or other suitable material.

It is believed that the water-based emulsion acts as a carrier to take the anti-oxidant compound (and other components of the composition) into the layers of the pearl thereby distributing the composition throughout the layers of the pearl. The small particle size of the water-based emulsion is believed to assist in the distribution of the composition throughout the layers of the pearl.

The pearl treatment composition may further comprise a fragrance concentrate, wherein the anti-oxidant compound is present in the fragrance concentrate. The fragrance concentrate may typically be present in a range of about 8-10% of the final composition. Various fragrance concentrates may be used depending on the final fragrance required. Well known fragrances may of course be used, presenting a marketing opportunity for incorporation of a well known perfume brand into the pearl treatment composition.

It is believed that the anti-oxidant compound (or fragrance concentrate) is the chief active ingredient which assists in preventing ageing of the pearls, with the water-based emulsion acting as the carrier to transport this anti-oxidant compound into the layers of the pearl, as described above. However it is also believed that the water-based emulsion (and any water added to the composition) assists in hydrating the layers of the pearl, thereby also assisting in the anti-ageing process.

The active chemical compound may in addition have some properties which allows is to act as a chemical marker for forensic identification purposes, such as a fluorescing compound.

The inclusion of a fragrance concentrate into the pearl treatment composition also allows a fragrance to be impregnated into the pearl which is typically released slowly over a period of time, presenting a marketing opportunity for the sale of “perfumed pearls”. This also provides a way for wearers of pearl jewellery to avoid the need for using alcohol based spray-on perfumes.

Preferably the water-based emulsion has a particle size of less than 0.5 microns. The water-based emulsion is preferably the emulsion sold under the trade mark “WPE” of the French laboratory AR2i. The water-based emulsion is preferably plant based.

The pearl treatment composition may also comprise further water as required to provide a composition of suitable aqueous concentration. The pearl treatment composition may also comprise a protein extract or protein concentrate.

The pearl treatment composition may also comprise a colour enhancer, such as silver lustre (Merck ref 1.20602). The pearl treatment composition may also comprise ceramides.

### EXAMPLE 1

### Composition

One example of the pearl treatment composition is as follows:
fragrance concentrate 10%
water-based emulsion (sold under the brand name WPE) 3.9% water 84.1%
Silver lustre (Merck 1.20602).

The ingredients may simply be stirred or shaken together at room temperature. The pearl treatment composition is usually white and cloudy looking in appearance.

A preferred method for the treatment of pearls comprises the steps of:
a) introducing into a bath an alcohol-free aqueous composition, the composition comprising an anti-oxidant compound and a water-based emulsion of particle size less than 1.0 microns;
b) introducing one or more pearls into the bath; and
c) operating the bath for a prescribed period to allow the alcohol-free aqueous composition to infuse into the one or more pearls in a first treatment step;
wherein, in use, the alcohol-free aqueous composition inhibits ageing of the one or more pearls.

The bath is preferably an ultrasonic bath. An ultrasonic bath has the benefit of allowing the pearl treatment composition to more rapidly penetrate the pearl matrix due to the ultrasonic vibration. Preferably the bath is operated at a temperature of less than 50° C. so that volatile substances in the composition are not lost on over-heating.

A typical commercial ultrasonic bath suitable for this purpose is the one sold under the brand name “Triton TR USR503” (Power 120 W; Frequency 40 KHZ; Capacity 4 L). The ultrasonic bath has a timer and a temperature controller.

The method may also comprise the step of placing the one or more pearls into a glass or stainless steel beaker prior to introducing the pearls in the beaker into the bath. Preferably the prescribed period of the first treatment step is about 15 to 60 minutes. More preferably the prescribed period is about 30 minutes.

Preferably the method further comprises a stirring step after the first treatment step in which the one or more infused pearls is stirred in the composition for a period of time. The period of time may be about 5 to 15 minutes. Following the stirring step, the bath containing the one or more infused pearls may be operated for a second prescribed period. Typically the second prescribed period is about 30 minutes.

The method may comprise a final drying step during which the one or more infused pearls may be removed from the bath, and dried at ambient temperature, for example room temperature of about 21 to 25° C.

Preferably the water-based emulsion has a particle size of less than 0.5 microns. The water-based emulsion is preferably the emulsion sold under the trade mark “WPE” of the French laboratory AR2i. The water-based emulsion is preferably plant based.

The penetration of the alcohol-free aqueous composition into the pearl may be readily measured by the usual techniques of GC-MS or other chromatography.

### EXAMPLE 2

### Method

A quantity of the pearl treatment composition is placed in a glass or stainless steel beaker. Pearls are introduced into the beaker so that the pearls are fully immersed in the composition. The beaker is placed in the ultrasonic bath which is set at or below room temperature. The ultrasonic bath is operated for about 30 minutes following which the pearls may be stirred by hand in the composition for a short period of time, for example 5 or 10 minutes. The ultrasonic bath may then be operated for a further 30 minutes, following which the pearls are removed from the beaker and dried on absorbent paper. The ultrasonic bath should be maintained at a temperature below 50° C., and preferably below 30° C.

### EXAMPLE 3

### Method

An alcohol-free aqueous composition comprising a water-based emulsion of particle size less than 1.0 microns is introduced into a pressure vessel. One or more pearls are then introduced into the pressure vessel, following which carbon dioxide is introduced into the pressure vessel. The pressure vessel is operated at a pressure in the range of +250 PSI to −2000 PSI for a prescribed period to allow the alcohol-free aqueous composition to infuse into the one or more pearls in a first treatment step, wherein, in use, the alcohol-free aqueous composition inhibits ageing of the one or more pearls. Preferably the water-based emulsion is mixed with an active chemical compound before introduction into the pressure vessel, the emulsion acting as a carrier to transport the active chemical compound into the pearl matrix.

### EXAMPLE 4

### Method

Carbon dioxide and an active chemical compound are introduced into a pressure vessel carbon dioxide. One or more pearls are then introduced into the pressure vessel. The pressure vessel is operated at a pressure in the range of +250 PSI to −2000 PSI for a prescribed period to allow the active chemical compound to infuse into the one or more pearls in a first treatment step, wherein, in use, the active chemical compound inhibits ageing of the one or more pearls.

As noted above, the method of the invention also has the potential to be employed for “biomarking” of pearls, i.e. by inclusion of a suitable marking compound into the pearl treatment composition, pearls may be “labelled” with a marker that can be used for security purposes, or dating of pearls. The marking compound would be carried into the layers of the pearl by the water-based emulsion. A suitable marking compound could be for example the fragrance concentrate or anti-oxidant compound that has specific identifying characteristics, or a fluorescing compound or an isotopically labelled compound.

Now that preferred embodiments of the alcohol-free aqueous pearl treatment composition, and method, of the invention have been described in detail, it will be apparent that the described embodiments provide a number of advantages over the prior art, including the following:
(i) The composition and method of the invention provides a relatively easy way of treating pearls against ageing.
(ii) Since the composition is alcohol-free, the composition itself does not damage pearls.
(iii) The use of a water-based emulsion such as WPE is a non-corrosive substance which does not damage the surface or internal layers of pearls.
(iv) The composition may be enhanced with a fragrance so that the treated pearls may slowly emit the fragrance avoiding the need for the wearer of the pearl jewellery to also wear perfume.
(v) The addition of a fragrance to the composition allows the composition to be easily varied and to present marketing opportunities especially with well known brands of perfume.
(vi) Since the method is relatively easy to use, the composition is suitable for home or retail use.
(vii) The composition is relatively stable and can be sold with pearl jewellery for later home or retail use.
(viii) Since the composition does not contain alcohol it is suitable for use in countries where alcohol is prohibited.

It will be readily apparent to persons skilled in the relevant arts that various modifications and improvements may be made to the foregoing embodiments, in addition to those already described, without departing from the basic inventive concepts of the present invention. For example, various compounds may be added to the alcohol-free aqueous pearl treatment composition not specifically mentioned in the specification, for example compositions that may assist in cleaning or whitening the pearls. Therefore, it will be appreciated that the scope of the invention is not limited to the specific embodiments described.

1. An alcohol-free aqueous pearl treatment composition comprising a water-based emulsion of particle size less than 1.0 microns, wherein, in use, the alcohol-free aqueous pearl treatment composition infuses into pearls to inhibit ageing of the pearls.

2. An alcohol-free aqueous pearl treatment composition as defined in claim 1, wherein the water-based emulsion of the alcohol-free aqueous pearl treatment composition is mixed with an active chemical compound, the emulsion acting as a carrier to transport the active chemical compound into the pearl matrix.

3. An alcohol-free aqueous pearl treatment composition as defined in claim 1, wherein the active chemical compound is selected from one or more of the group comprising an anti-oxidant compound, a chelating agent, pheromone, radioactive substance, luminescent substance, fluorophores, phosphorescent substance, essential oils, or pearl nacre powder.

4. An alcohol-free aqueous pearl treatment composition as defined in claim 1, wherein the active chemical compound is a marker substance such as a fluorescing compound or isotopically labelled compound which may be used for biomarking or forensic identification of the pearls.

5. An alcohol-free aqueous pearl treatment composition as defined in claim 3, wherein the anti-oxidant compound may be one or more of a perfume composition, butylated hydroxyanisole, butylated hydroxytoluene, propyl gallate, tocopherol, ascorbyl palmitate, alpha tocopheryl acetate, co-enzyme Q10, magnesium ascorbyl phosphate, arbutin, resveratrol, kojic acid, pentaerythrityl tetra di-tertiary butyl hydroxyhydrocinnamte, or superoxide dismutase.

6. An alcohol-free aqueous pearl treatment composition as defined in claim 3, wherein the chelating agent may be tetrasodium EDTA, tetrahydroxypropyl ethylenediamine or Glucono-Delta-Lactone (GDL).

7. An alcohol-free aqueous pearl treatment composition as defined in claim 3, further comprising a fragrance concentrate, wherein the anti-oxidant compound is present in the fragrance concentrate.

8. An alcohol-free aqueous pearl treatment composition as defined in claim 7, wherein the fragrance concentrate is present in a range of about 8-10% of the final composition.

9. An alcohol-free aqueous pearl treatment composition as defined in claim 1, wherein the water-based emulsion has a particle size of less than 0.5 microns.

10. An alcohol-free aqueous pearl treatment composition as defined in claim 1, wherein the water-based emulsion is the emulsion sold under the trade mark “WPE” of the French laboratory AR2i.

11. An alcohol-free aqueous pearl treatment composition as defined in claim 1, wherein the water-based emulsion is plant-based.

12. An alcohol-free aqueous pearl treatment composition as defined in claim 11, wherein the water-based plant emulsion comprises harmless plant emulsifiers, such as saponins.

13. An alcohol-free aqueous pearl treatment composition as defined in claim 11, wherein the water-based plant emulsions may contain up to 40% oily substances.

14. An alcohol-free aqueous pearl treatment composition as defined in claim 1, further comprising further water as required to provide a composition of suitable aqueous concentration.

15. An alcohol-free aqueous pearl treatment composition as defined in claim 1, further comprising a protein or amino acid extract such as conchiolin, perlucin Arginine, lysine, histidine, phenylalanine, tyrosine, leucine, isoleucine, methionine, valine, alanine, glycine, proline, glutamic acid, serine, threonine, aspartic acid, tryptophan, cystine, and taurine.

16. An alcohol-free aqueous pearl treatment composition as defined in claim 1, further comprising a colour enhancer, such as silver lustre (Merck ref 1.20602).

17. An alcohol-free aqueous pearl treatment composition as defined in claim 1, further comprising ceramides, such as sphingolipids which are composed of a sphingosine and a fatty acid, wherein the fatty acid may be any of the fatty acids found in human borne triglycerides and may include cerebroside, galactocerbroside, glucerebroside and lactosylceramide.

18. An alcohol-free aqueous pearl treatment composition as defined in claim 1, comprising: 0.01%-30% pearl nacre; fragrance concentrate 0.01%-29%; active chemical compound 0.01%-29%; and, water-based emulsion 70%-99%.

19. An alcohol-free aqueous pearl treatment composition as defined in claim 1, comprising the following: fragrance concentrate 10%; WPE 3.9%; water 84.1%; and, silver lustre (Merck 1.20602).

20. An alcohol-free aqueous pearl treatment composition as defined in claim 1, wherein the aqueous pearl treatment composition can also act as a chemical marker for forensic identification when the composition is infused into the pearl.

21. An alcohol-free aqueous pearl derivative treatment composition comprising a water-based emulsion of particle size less than 1.0 microns, wherein, in use, the alcohol-free aqueous pearl derivative treatment composition infuses into the pearl derivative to inhibit ageing of the pearl derivative.

22. An alcohol-free aqueous pearl derivative treatment composition as defined in claim 21, wherein the pearl derivative is pearl nacre.

23. An alcohol-free aqueous pearl treatment composition comprising:
i) a water-based emulsion of particle size less than 1.0 microns; and
ii) a perfume concentrate; wherein, in use, the water-based emulsion acts as a carrier for the perfume concentrate to allow the perfume to infuse into the body of the pearl.

24. An alcohol-free aqueous pearl treatment composition comprising: i) an anti-oxidant compound; and ii) a water-based emulsion of particle size less than 1.0 microns; wherein, in use, the alcohol-free aqueous pearl treatment composition infuses into pearls to inhibit ageing of the pearls.

25. An alcohol-free aqueous pearl treatment composition comprising a water-based emulsion of particle size less than 1.0 microns, wherein, in use, the alcohol-free aqueous pearl treatment composition infuses into pearls to provide a benefit.

26. An alcohol-free aqueous pearl treatment composition as defined in claim 25, wherein the benefit to the pearls is to inhibit ageing of the pearls, and/or nourishment or hydration of the pearls.

27. An alcohol-free aqueous pearl treatment composition comprising a water-based solution of particle size less than 1.0 microns, wherein, in use, the alcohol-free aqueous pearl treatment composition infuses into pearls to inhibit ageing of the pearls.

28. A method for the treatment of pearls comprising the steps of:
a) introducing into a bath an alcohol-free aqueous composition, the composition comprising a water-based emulsion of particle size less than 1.0 microns;
b) introducing one or more pearls into the bath; and
c) operating the bath for a prescribed period to allow the alcohol-free aqueous composition to infuse into the one or more pearls in a first treatment step;
wherein, in use, the alcohol-free aqueous composition inhibits ageing of the one or more pearls.

29. A method for the treatment of pearls as defined in claim 28, wherein the composition also comprises an active chemical compound mixed with the water-based emulsion.

30. A method for the treatment of pearls as defined in claim 29, wherein the active chemical compound is selected from a group comprising one or more of an anti-oxidant compound, a chelating agent, or pearl nacre powder.

31. A method for the treatment of pearls as defined in claim 28, wherein the water-based emulsion has a particle size of less than 0.5 microns.

32. A method for the treatment of pearls as defined in claim 28, wherein the bath is an ultrasonic bath.

33. A method for the treatment of pearls as defined in claim 28 wherein the bath is operated at a temperature of less than 50° C.

34. A method for the treatment of pearls as defined in claim 28, further comprising the step of operating the bath under elevated pressure.

35. A method for the treatment of pearls as defined in claim 34, wherein the pressure is about 800 kPa.

36. A method for the treatment of pearls as defined in claim 34, wherein the step of operating the bath under elevated pressure takes place for about 15 to 60 minutes.

37. A method for the treatment of pearls comprising the steps of:
a) introducing into a pressure vessel an alcohol-free aqueous composition, the composition comprising a water-based emulsion of particle size less than 1.0 microns;
b) introducing one or more pearls into the pressure vessel;
c) introducing carbon dioxide into the pressure vessel; and
d) operating the pressure vessel at a pressure in the range of +250 PSI to −2000 PSI for a prescribed period to allow the alcohol-free aqueous composition to infuse into the one or more pearls in a first treatment step;
wherein, in use, the alcohol-free aqueous composition inhibits ageing of the one or more pearls.

38. A method for the treatment of pearls comprising the steps of:
a) introducing into a pressure vessel carbon dioxide and an active chemical compound;
b) introducing one or more pearls into the pressure vessel;
c) operating the pressure vessel at a pressure in the range of +250 PSI to −2000 PSI for a prescribed period to allow the active chemical compound to infuse into the one or more pearls in a first treatment step;
wherein, in use, the active chemical compound inhibits ageing of the one or more pearls.
